(19) United States
(12) Patent Application Publication
(10) Pub. No.: US 2012/0002331 A1
(43) Pub. Date: Jan. 5, 2012

(54) MAGNETIC RECORDING HEAD AND MAGNETIC RECORDING APPARATUS

(75) Inventors: Soichi OIKAWA, Hachioji-shi (JP); Kenichiro YAMADA, Tokyo (JP); Katsuhiko KOUI, Yokohama-shi (JP); Masayuki TAKAGISHI, Kunitachi-shi (JP)

(73) Assignee: Kabushiki Kaisha Toshiba, Tokyo (JP)

(21) Appl. No.: 13/171,206

(22) Filed: Jun. 28, 2011

(30) Foreign Application Priority Data
Jun. 30, 2010 (JP) 2010-150039

(51) Int. Cl. G11B 5/33

(52) U.S. Cl. 360/328; G9B/5.104

(57) ABSTRACT

According to one embodiment, there is provided a magnetic recording head including a main pole, and a spin torque oscillator provided adjacent to the main pole and includes an oscillation layer including a first magnetic layer and a second magnetic layer and a third magnetic layer provided closer to the second magnetic layer and configured to inject a spin into the oscillation layer. The first magnetic layer has a saturation flux density of 1 T or more and 1.9 T or less.

### CROSS-REFERENCE TO RELATED APPLICATIONS

This application is based upon and claims the benefit of priority from Japanese Patent Application No. 2010-150039, filed Jun. 30, 2010; the entire contents of which are incorporated herein by reference.

### FIELD

Embodiments described herein relate generally to a magnetic recording head and a magnetic recording apparatus.

### BACKGROUND

A magnetic recording head based on a high-frequency assist recording scheme is known which head includes a spin torque oscillator (STO) with an oscillation layer and a spin injection layer to apply a high-frequency assist field to a magnetic recording medium.

However, variations in manufacturing conditions and an operational environment for the magnetic recording head are conventionally not taken into account. Thus, the oscillation frequency of STO may vary. As a result, the oscillation frequency of STO deviates from the optimum value for resonance with a magnetic recording medium. Thus, a manufactured magnetic recording head may have difficulty providing a stable and sufficient recording capability. This conventionally reduces the yield of the magnetic recording head.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of read and write heads according to an embodiment;

FIG. 2 is an exploded perspective view showing a magnetic recording apparatus according to an embodiment;

FIG. 3 is a diagram illustrating the relationship between the oscillation frequency and circular-polarized high-frequency field intensity c-Hac of STO according to Example 1;

FIG. 4 is a diagram illustrating the relationship between the oscillation frequency of STO and a field Hc required for magnetization reversal of a single magnetic grain in a magnetic recording medium according to Example 1;

FIG. 5 is a diagram illustrating the relationship between the circular-polarized high-frequency field c-Hac and signal-to-noise ratio SNR of STO according to Example 1;

FIG. 6 is a diagram illustrating oscillation frequencies at which STO according to Example 2 can generate a circular-polarized high-frequency field intensity of 400 Oe or more; and

FIG. 7 is a diagram illustrating oscillation frequencies at which STO according to Example 3 can generate a circular-polarized high-frequency field intensity of 400 Oe or more.

### DETAILED DESCRIPTION

Various embodiments will be described hereinafter with reference to the accompanying drawings.

In general, according to one embodiment, there is provided a magnetic recording head including a main pole, and a spin torque oscillator provided adjacent to the main pole and comprising an oscillation layer including a first magnetic layer and a second magnetic layer and a third magnetic layer provided closer to the second magnetic layer and configured to inject a spin into the oscillation layer. The first magnetic layer has a saturation flux density of 1 T or more and 1.9 T or less.

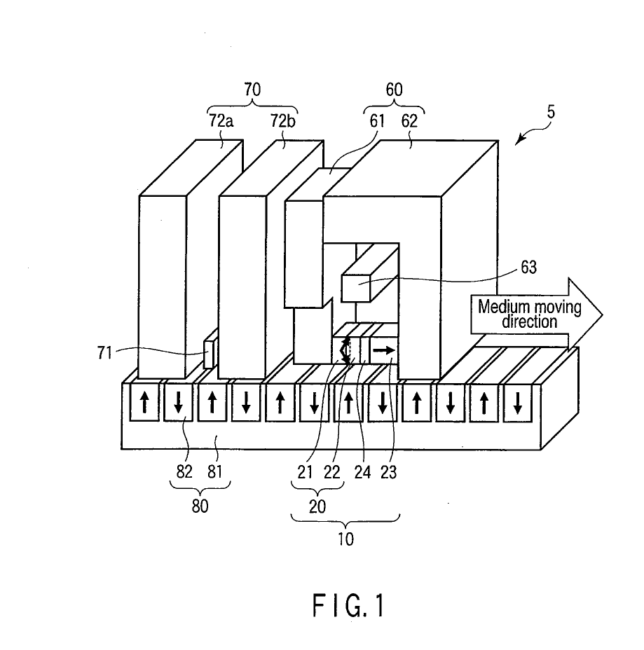

FIG. 1 is a perspective view of a magnetic recording head according to the embodiment. The magnetic recording head 5 according to the embodiment comprises a read head 70 and a write head 60. The read head 70 comprises a magnetic shield layer 72a, a magnetic shield layer 72b, and a magnetic read element 71 provided between the magnetic shield layer 72a and the magnetic shield layer 72b. The magnetic read element 71 utilized may be a GMR element or a TMR element. The write head 60 comprises a main pole 61, a return yoke 62, an excitation coil 63 wound around a magnetic path including the main pole 61 and the return yoke 62, and a spin torque oscillator 10 provided in the gap between the main pole 61 and the return yoke 62. The components of the read head 70 and the components of the write head 60 are separated from one another by insulators such as alumina (not shown in the drawings).

The spin torque oscillator 10 is provided in the gap between the main pole 61 and the return yoke 62. The spin torque oscillator 10 according to the present embodiment comprises an oscillation layer (FGL) 20 including a first magnetic layer 21 and a second magnetic layer 22, a third magnetic layer (spin injection layer) 23 provided closer to the second magnetic layer 22 and configured to inject a spin into the oscillation layer 20, and an intermediate layer 24 provided between the second magnetic layer 22 and the third magnetic layer 23. In FIG. 1, the first magnetic layer 21, the second magnetic layer 22, the intermediate layer 24, and the third layer 23 are stacked in this order from the main pole 61 toward the return yoke 62. The intermediate layer 24 need not necessarily be provided. Conductors may be provided between the main pole 61 and the first magnetic layer 21 and between the third magnetic layer 23 and the return yoke 62 so that the main pole 61 and the return yoke 62 can also be used as electrodes, though this is not shown in FIG. 1. In this case, a current can be efficiently distributed to the spin torque oscillator 10 by insulating a back gap contacted by the main pole 61 and the return yoke 62 or setting the resistance of the back gap equivalent to or greater than that of the spin torque oscillator 10.

A magnetic recording medium 80 comprises a substrate 81 and a magnetic recording layer 82 provided on the substrate 81. Write is carried out when the magnetic recording layer 82 is magnetized in a perpendicular direction by a field applied by the write head 60. The read head 70 reads the direction of magnetization in the magnetic recording layer 82.

When a current is allowed to flow through the spin torque oscillator 10 in a direction perpendicular to a film plane, the magnetization in the oscillation layer 20 makes precession to allow a high-frequency field to be generated. When the high-frequency field is adjusted so as to resonate with the magnetic recording layer 82, a reduction can be attained in a field required for magnetization reversal of a single medium grain in the magnetic recording layer 82, that is, a write field.

The first magnetic layer 21 of the oscillation layer 20 has a saturation flux density of 1 T or more and 1.9 T or less. The first magnetic layer 21 is preferably formed of a soft magnetic material. The soft magnetic material used may be, for example, an alloy containing at least one of Ni, Fe, and Co such as NiFe, FeCoAl, FeCoSi, FeNiCo, CoFe, or FeSi or a Heusler alloy such as CoMnSi, CoFeMnSi, CoFeAlSi, CoMnAl, CoMnGaSn, CoMnGaGe, CoCrFeSi, or CoFeCrAl. Provided that the first magnetic layer has a saturation flux density of 1 T or more and 1.9 T or less, the optimum STO oscillation frequency for resonance with the magnetic recording medium can be obtained even if the oscillation frequency of STO varies as a result of variations in manufacturing conditions and an operational environment for the magnetic recording head. Furthermore, a trace element serving to adjust magnetostriction, for example, Nb, B, or Ge may be added to the first magnetic layer 21. Moreover, the first magnetic layer 21 may be formed of a stack of a material such as FeCo which has positive magnetostriction and a material such as NiFe or FeCoNi which has negative magnetostriction. When the average of the magnetostriction in the first magnetic layer 21 and the magnetostriction in the second magnetic layer 22 is adjusted to have an absolute value of 10⁻⁶ or less, a variation in stress dependent on the head manufacturing conditions can be suppressed to provide the optimum STO oscillation frequency for resonance with the magnetic recording medium.

A material used as the second magnetic layer 22 of the oscillation layer 20 is, for example, FeCo, FeCo/Cu, FeCO/Ni, or FeCoAl, which has a saturation flux density of, for example, 2.2 T or more. These materials have high spin polarization, and can thus interact efficiently with a spin torque from the spin injection layer. This is advantageous in reducing applied current density.

Here, preferably, the magnetic thickness (saturation flux density Bs×thickness t) of the second magnetic layer 22 is 50% or more and 75% or less of the sum of the magnetic thicknesses of the first magnetic layer 21 and the second magnetic layer 22. When the magnetic thicknesses of the first magnetic layer 21 and the second magnetic layer 22 meet the above-described conditions, the optimum STO oscillation frequency for resonance with the magnetic recording medium can be obtained even if the oscillation frequency of STO varies as a result of variations in the manufacturing conditions and operational environment for the magnetic recording head.

The third magnetic layer (spin injection layer) 23 is preferably a magnetic layer with perpendicular magnetic anisotropy. Any material excellent in perpendicular magnetic anisotropy may be appropriately used, such as a CoCr-containing magnetic layer, for example, CoCrPt, CoCrTa, CoCrTaPt, or CoCrTaNb, an RE-TM-containing amorphous alloy magnetic layer, for example, an artificial lattice magnetic layer of a Co alloy such as TbFeCo, Co/Pd, Co/Pt, CoCrTa/Pd, Co/Ni, or Co/NiPt, and an alloy containing a platinum group element such as Pd, Pt, or Ni, an alloy magnetic layer containing CoPt or FePt, or an SmCo-containing alloy magnetic layer. Furthermore, of course, the following may be stacked: the material excellent in perpendicular magnetic anisotropy and the materials used for the first magnetic layer 22 and the second magnetic layer 23. For example, the second magnetic layer side of the third magnetic layer may be formed of a Heusler alloy such as CoMnSi, CoFeMnSi, CoFeAlSi, CoMnAl, CoMnGaSn, CoMnGaGe, CoCrFeSi, or CoFeCrAl, whereas the other side may be formed of the material with perpendicular magnetic anisotropy. Since the Heusler alloy has high spin polarization, the above-described configuration advantageously allows the torque efficiency of the spin torque from the spin injection layer to be improved to reduce the applied current density.

A material for the intermediate layer is preferably a nonmagnetic substance. The nonmagnetic substance may be rare metal, for example, Cu, Pt, Au, Ag, Pd, or Ru, or a nonmagnetic transition metal, for example, Cr, Rh, Mo, or W. Alternatively, the intermediate layer 24 may have a current confinement structure formed of an alumina matrix and Cu or an alumina matrix and a NiFe alloy. Use of any of the above-described materials for the intermediate layer 24 enables reduction in variation in the exchange coupling force between the second magnetic layer 22 and the third magnetic layer 23 without reduction in the torque efficiency of the spin torque between the second magnetic layer 22 and the third magnetic layer 23. As a result, the oscillation frequency of STO can be reduced.

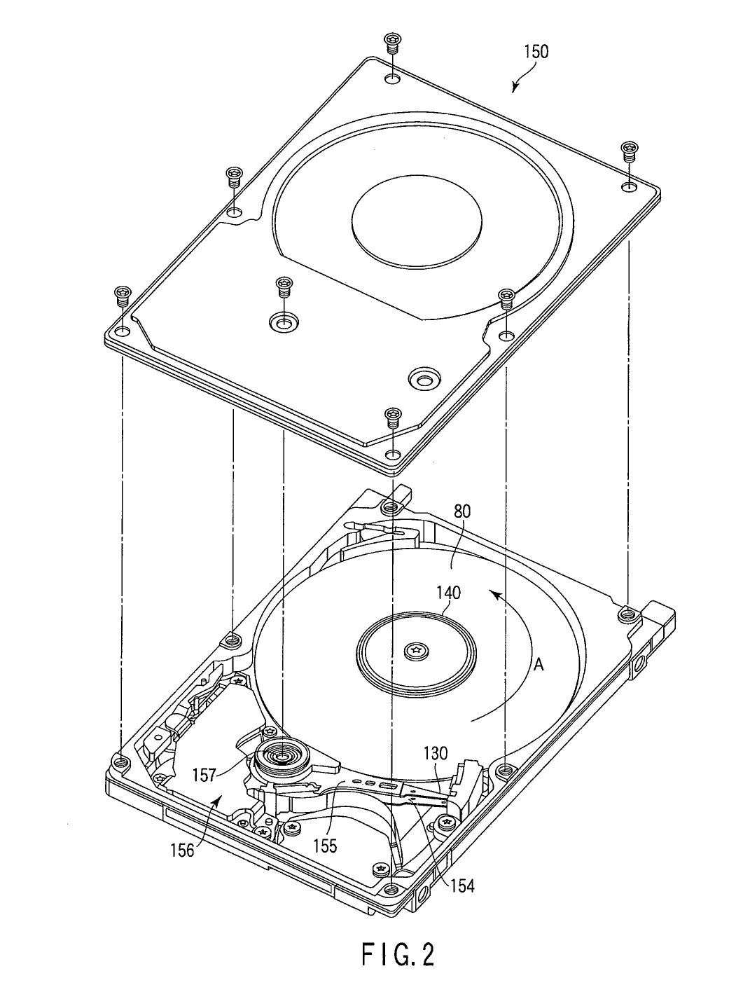

FIG. 2 is a perspective view showing a magnetic recording apparatus 150 with the magnetic recording head according to the embodiment mounted therein.

As shown in FIG. 2, the magnetic recording apparatus 150 is of a type using a rotary actuator. The magnetic recording medium 80 is installed on a spindle motor 140 and rotated in the direction of arrow A by a motor (not shown in the drawing) configured to respond to a control signal from a drive control system (not shown in the drawing). The magnetic recording apparatus 150 may comprise a plurality of magnetic recording media 80.

A head slider 130 configured to read and write information from and on the magnetic recording medium 80 is attached to the tip of a thin film-like suspension 154. The magnetic recording head according to the embodiment is provided close to the tip of the head slider 130. When the magnetic recording medium 80 rotates, a pressure exerted by the suspension 154 comes into balance with a pressure generated by the air bearing surface (ABS) of the head slider 130. The air bearing surface of the head slider 130 is held so as to lie above and at a predetermined distance from the surface of the magnetic recording medium 80.

The suspension 154 is connected to one end of an actuator arm 155 with a bobbin portion configured to hold a driving coil (not shown in the drawing). A voice coil motor 156, a linear motor, provided at the other end of the actuator arm 155. The voice coil motor 156 can be formed of the driving coil (not shown in the drawing) wound around the bobbin portion of the actuator arm 155 and a magnetic circuit formed of a permanent magnet and an opposite yoke arranged opposite each other and between which the coil is sandwiched. The actuator arm 155 is held by two ball bearings (not shown in the drawing) provided at an upper point and a lower point, respectively, on a pivot 157. The actuator arm 155 can be freely slidably actuated by the voice coil motor 156. As a result, the magnet head can access any position on the magnetic recording medium 80.

### Example 1

As shown in FIG. 1, the spin torque oscillator 10 is provided in the gap between the main pole 61 and the return yoke 62. The spin torque oscillator (STO) 10 is configured such that the oscillation layer (FGL) 20 including the first magnetic layer 21 and the second magnetic layer 22, the intermediate layer 24, and the third magnetic layer 23 are stacked in this order from the main pole 61 toward the return yoke 62.

In the present example, the oscillation layer (FGL) 20 of the spin torque oscillator (STO) 10 is formed of a stack film comprising the first magnetic layer 21 formed of NiFe with a saturation flux density of 1 T and a thickness of 11.5 nm, and the second magnetic layer 22 formed of FeCo with a saturation flux density of 2.3 T and a thickness of 5 nm. The intermediate layer 24 is formed of Cu with a thickness of 3 nm. The third magnetic layer 23 is formed of a Co/Ni artificial lattice layer of thickness 12 nm.

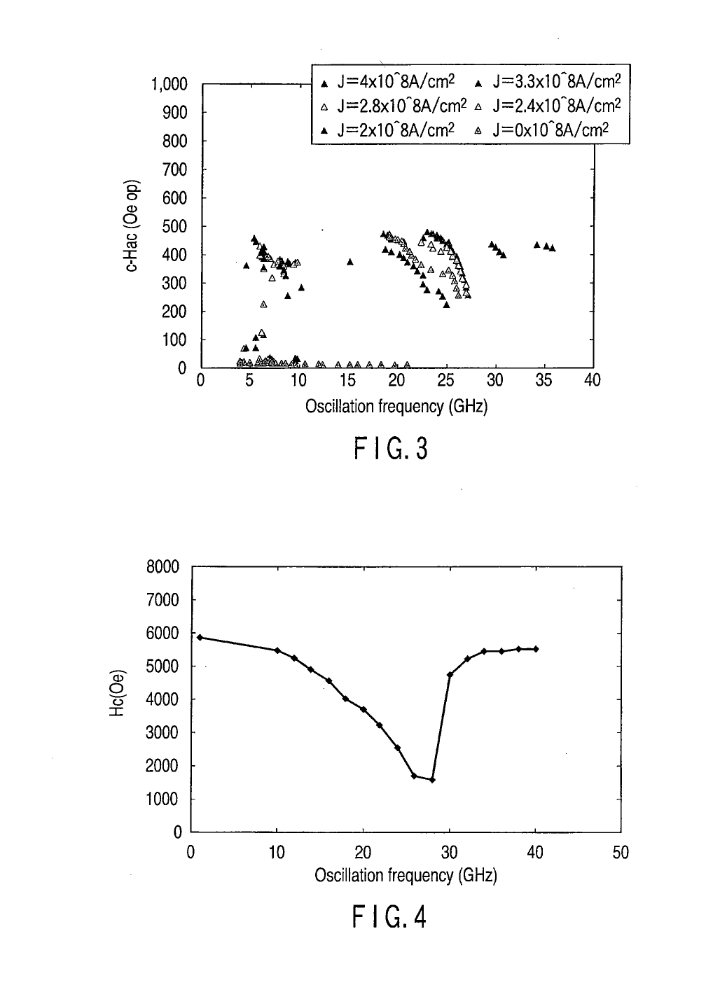

FIG. 3 illustrates the relationship between the oscillation frequency and circular-polarized high-frequency field intensity c-Hac of STO. As illustrated in FIG. 3, varying the density of a current applied to STO allows high frequencies to be generated at various oscillation frequencies and circular-polarized high-frequency field intensities.

FIG. 4 illustrates the relationship between the oscillation frequency of STO and a field Hc required for magnetization reversal of a single magnetic grain in the magnetic recording medium. The applied circular-polarized high-frequency field intensity c-Hac is 400 Oe. Without any high-frequency field, the field Hc required for magnetization reversal is 6000 Oe. In contrast, if a high-frequency field of oscillation frequency 15 to 27 GHz is applied, the field Hc required for magnetization reversal decreases to 4000 Oe or less. A high-frequency assist effect serves to reduce the field Hc required for magnetization reversal, allowing a sufficient recording capability to be provided.

FIG. 5 illustrates the relationship between the circular-polarized high-frequency field intensity c-Hac and signal-to-noise ratio SNR of STO. Setting the circular-polarized high-frequency field intensity c-Hac to 400 Oe or more enables the signal-to-noise ratio to be set to 10 dB or more. This allows sufficient read and write characteristics to be obtained. On the other hand, if the circular-polarized high-frequency field intensity c-Hac is lower than 400 Oe, the signal-to-noise ratio SNR is lower than 10 dB. Then, the read and write characteristics are rapidly degraded. Thus, the circular-polarized high-frequency field intensity c-Hac is preferably set to 400 Oe or more.

Furthermore, the oscillation frequency of STO varies by 5 GHz as a result of variations in the manufacturing conditions and operational environment for the recording head. In contrast, if the high-frequency field has an oscillation frequency of 15 to 27 GHz, the circular-polarized high-frequency field intensity c-Hac can be set to 400 Oe or more. Hence, stable recording can be achieved regardless of variations in manufacturing conditions and operational environment.

### Example 2

In the present example, combinations of the first magnetic layer and second magnetic layer illustrated in 2A to 2E in Table 1 were used for the oscillation layer 20 of the spin torque oscillator 10. The second magnetic layer used was formed of FeCo with a saturation flux density of 2.3 T and a thickness of 5 nm. Materials with different saturation flux densities Bs were used for the first magnetic layer in which the thickness of the first magnetic layer was adjusted. Thus, the magnetic thickness of the second magnetic layer (the product of the saturation flux density Bs and the thickness) is set equal to 50% of the sum of the magnetic thicknesses of the first magnetic layer and the second magnetic layer.

TABLE 1

| | First | Second |
|---|---|---|
| | magnetic layer | magnetic layer |
| 2A | NiFe (0.7 T) | FeCo (2.3 T) |
| | 16.4 nm | 5 nm |
| 2B | NiFe (1 T) | FeCo (2.3 T) |
| | 11.5 nm | 5 nm |
| 2C | FeCoAl (1.25 T) | FeCo (2.3 T) |
| | 9.2 nm | 5 nm |
| 2D | FeCoSi (1.5 T) | FeCo (2.3 T) |
| | 7.7 nm | 5 nm |
| 2E | FeNiCo (1.9 T) | FeCo (2.3 T) |
| | 6.1 nm | 5 nm |

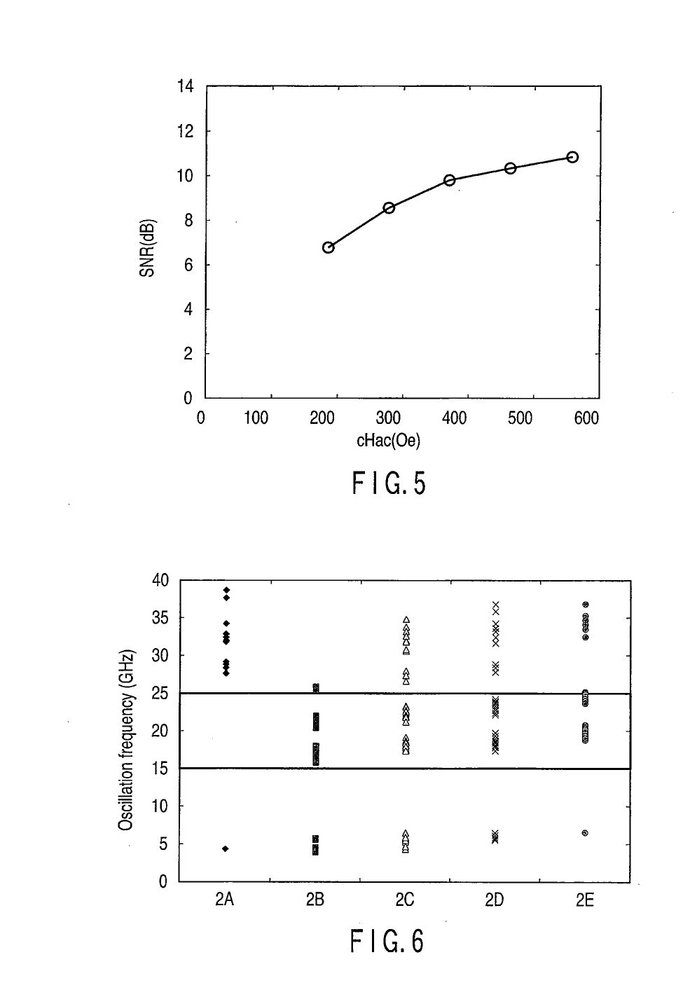

FIG. 6 illustrates oscillation frequencies at which STOs with the oscillation layers illustrated in 2A to 2E can generate a circular-polarized high-frequency field intensity c-Hac of 400 Oe or more. A circular-polarized high-frequency field intensity c-Hac of 400 Oe or more allows a sufficient recording capability to be achieved based on the high-frequency assist effect. Furthermore, an oscillation frequency of 15 to 27 GHz allows variations in the manufacturing conditions and operational environment for the recording head to be compensated for to reduce the field Hc required for magnetization reversal based on the high-frequency assist effect. Thus, a sufficient recording capability can be provided. As illustrated in FIG. 6 and Table 1, a sufficient recording capability can be provided by setting the saturation flux density Bs of the first magnetic layer to 1 T or more and 1.9 T or less. Furthermore, in this example, FeCO, which offers high spin polarization, is used for the second magnetic layer that is in contact with the intermediate layer. Hence, the oscillation layer can be oscillated at a sufficiently low current density.

### Example 3

In the present example, combinations of the first magnetic layer and second magnetic layer illustrated in 3A to 3E in Table 1 were used for the oscillation layer 20 of the spin torque oscillator 10. FeCo with a saturation flux density of 2.3 T was used for the second magnetic layer. NiFe with a saturation flux density of 1 T was used for the first magnetic layer. The thicknesses of the first magnetic layer and the second magnetic layer were adjusted. The above-described configuration was used to vary the ratio of the magnetic thickness (the product of the saturation flux density Bs and the thickness) of the second magnetic layer to the sum of the magnetic thicknesses of the first magnetic layer and the second magnetic layer.

TABLE 2

| | First | Second | Ratio of magnetic |
|---|---|---|---|
| | magnetic | magnetic | thickness of second |
| | layer | layer | magnetic layer |
| 3A | — | FeCo (2.3 T) | 100% |
| | | 10 nm | |
| 3B | NiFe (1 T) | FeCo (2.3 T) | 75% |
| | 7 nm | 7.5 nm | |
| 3C | NiFe (1 T) | FeCo (2.3 T) | 50% |
| | 11.5 nm | 5 nm | |
| 3D | NiFe (1 T) | FeCo (2.3 T) | 25% |
| | 17.3 nm | 2.5 nm | |
| 3E | NiFe (1 T) | — | 0% |
| | 23 nm | | |

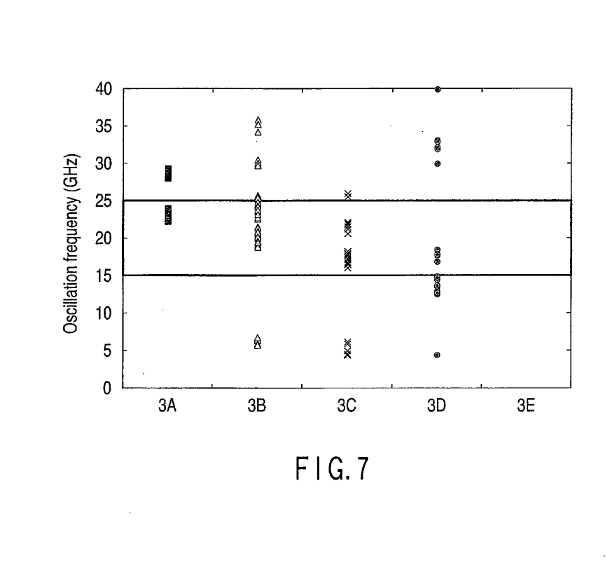

FIG. 7 illustrates oscillation frequencies at which STOs with the oscillation layers illustrated in 3A to 3E can generate a circular-polarized high-frequency field intensity c-Hac of 400 Oe or more. As described above, an oscillation frequency of 15 to 27 GHz is preferably achieved in order to compensate for variations in the manufacturing conditions and operational environment for the magnetic recording head. FIG. 7 and Table 2 indicate that when the ratio of the magnetic thickness of the second magnetic layer to the sum of the magnetic thicknesses of the first magnetic layer and the second magnetic layer is 50% or more and 75% or less, an oscillation frequency of 15 to 27 GHz can be easily achieved to provide a sufficient recording capability based on the high-frequency assist effect.

On the other hand, if the oscillation layer is formed only of FeCO, the oscillation frequency is biased toward a high frequency, thus preventing stable recording. Furthermore, if the oscillation layer is formed only of NiFe, a circular-polarized high-frequency field intensity of 400 Oe or more cannot be generated. As a result, stable recording cannot be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording head comprising:
a main pole; and
a spin torque oscillator provided adjacent to the main pole and comprising an oscillation layer including a first magnetic layer and a second magnetic layer and a third magnetic layer provided closer to the second magnetic layer and configured to inject a spin into the oscillation layer,
wherein the first magnetic layer has a saturation flux density of 1 T or more and 1.9 T or less.

2. The magnetic recording head of claim 1, further comprising an intermediate layer between the second magnetic layer and the third magnetic layer.

3. The magnetic recording head of claim 1, wherein the second magnetic layer has a magnetic thickness that is 50% or more and 75% or less of a sum of a magnetic thickness of the first magnetic layer and a magnetic thickness of the second magnetic layer.

4. The magnetic recording head of claim 1, wherein the second magnetic layer is a Fe—Co alloy.

5. A magnetic recording apparatus comprising the magnetic recording head of claim 1 and a magnetic recording medium.
